(19) United States
(12) Patent Application Publication
(10) Pub. No.: US 2021/0109910 A1
(43) Pub. Date: Apr. 15, 2021

(54) NODE, NETWORK SYSTEM AND METHOD OF DATA SYNCHRONISATION

(71) Applicant: EWAB ENGINEERING AB, Vadstena (SE)

(72) Inventors: Ingo Georg, Munden (DE); Roland Lundin, Vadstena (SE)

(21) Appl. No.: 17/041,107

(22) PCT Filed: Mar. 22, 2019
(86) PCT No.: PCT/EP2019/057301

§ 371 Date: Sep. 24, 2020

(30) Foreign Application Priority Data
Mar. 26, 2018 (SE) 1850333-4

(51) Int. Cl. G06F 16/21; G06F 16/23; H04L 12/26; H04L 29/08

(52) U.S. Cl. CPC G06F 16/219; G06F 16/2379; H04L 67/1097; H04L 67/1095; H04L 43/10

(57) ABSTRACT

The present disclosure provides a node, comprising: a data storage unit configured to store a plurality of data entries, each data entry comprising a data entry ID, a data entry version identifier, and a data payload representing operating information of the node or another node; a processing unit; a first interface for communicating with another node. The node is configured to transmit a first data packet comprising data entry ID and data entry version identifier of a data entry in the data storage unit, to other nodes; and to receive a second data packet transmitted by said another node, the second data packet comprising data entry ID and data entry version identifier of a data entry of said another node; and compare the received data entry version identifier of the second data packet, with a data entry version identifier of a corresponding data entry in the data storage unit having a same data entry ID as the second data packet.

### TECHNICAL FIELD

The present document relates to a node, a network system, and a method of data synchronisation between a plurality of nodes of a network system.

The node is suitable for use in a network system for providing an automatic data synchronisation between different nodes, i.e. a network system wherein data is synchronised between nodes without human intervention and without any central control node.

### BACKGROUND

A network system is a system comprising a plurality of nodes linked together for sharing resources or information. The data links are normally established over wired media, such as optic cables, or wireless media, such as Wi-Fi. Since network systems are known for convenient and efficient data exchange, they are widely used in our daily lives, such as computer networks, telecommunications, cloud computing, television networks. Other applications include industrial type control systems for controlling the handling and movement of items in connection with manufacturing and/or warehousing. Yet further applications include internal communication networks in vehicles, for communication between various components of the vehicle.

A network system normally comprises a plurality of nodes, which are capable of creating, receiving, or transmitting information over a communication channel connected to another node.

For a wide variety of applications of the network system, such as file synchronization, it is fundamental to maintain data consistency among different nodes of the network system over time. Thus, a continuous synchronization between certain data from a source node to a target node of the network system and vice versa is needed. For example, if one node is informed that another node's malfunction, it may stop sending data to the abnormal node but route data to other functional nodes, such that the data will not be lost and the data transmission will not be delayed. Consequently, a need for rebalancing the data handling capacities of the nodes in the network system due to the abnormal node, which normally involves a central control node and a significant amount of labour, would be avoided, such that the efficiency and robustness of the network system can be improved.

Moreover, it is desirable to be able to reconfigure nodes through a robust procedure.

Hence, there is a need for a node which can improve the efficiency and robustness of the network system with reduced human intervention.

### SUMMARY

It is an object of the present disclosure, to provide an improved node, and in particular a node which can improve the efficiency and robustness of a network system with reduced human intervention.

The invention is defined by the appended independent claims, with embodiments are set forth in the appended dependent claims and in the following description and drawings.

According to a first aspect, there is provided a node, comprising a data storage unit configured to store a plurality of data entries, each data entry comprising a data entry ID, a data entry version identifier, and a data payload representing operating information of the node or another node. The node further comprises a processing unit and a first interface for communicating with said another node. The node is configured to transmit a first heartbeat data packet comprising data entry ID and data entry version identifier of a data entry in the data storage unit, via the first interface, to other nodes. The node is configured to receive a second heartbeat data packet transmitted by said another node, via the first interface, the second heartbeat data packet comprising data entry ID and data entry version identifier of a data entry of said another node. The node is configured to compare the received data entry version identifier of the second heartbeat data packet, with a data entry version identifier of a corresponding data entry in the data storage unit having a same data entry ID as the second heartbeat data packet. When the node determines that the data entry stored in its storage unit is newer than the corresponding data entry in said another node, the node is configured to transmit to said another node a first synchronizing data packet comprising the data entry ID, the data entry version identifier, and at least a portion of the data payload, of the corresponding data entry in the data storage unit. A size of the first synchronizing data packet is greater than a size of the first heartbeat data packet.

The first data packet may consist essentially of the data entry ID and data entry version identifier of the data entry in the data storage unit.

By comprising only the data entry ID and the corresponding data entry version identifier of one or a plurality of data entries, the first data packet may be used for broadcasting the data entry version identifier for the data entry with only a small amount of data.

When one node is to trigger the synchronization of other nodes, the transmitted first synchronization data packet may have a larger size by comprising additional data for synchronization, such as a portion of a data payload.

An advantage of controlling the contents and/or sizes of the transmitted data packets is that as only the node to trigger the synchronization may transmit a data packet with a larger size, while all other data packets have a relatively small size, such that even if the network system comprises a large number of nodes, i.e. a large number of data packets communicated between the nodes in the same time, a data communication channel with a narrow bandwidth can handle the communication of data packets between the nodes, which also reduce the cost and complexity for implementing the network system.

Moreover, the flexibility of the method and the node of the present disclosure is improved such that they can be used in a network system comprising even a large number of nodes without any modification which otherwise is necessary for handling issues caused by a large number or a large size of the transmitted and/or received data packets.

It is also advantageous as when a new node needs to be installed in a network system comprising a plurality of the present nodes, or an existing node needs to be reconfigured, the node may be automatically synchronized to the other nodes by the synchronization triggered by those nodes having “newer” data entries. Thus, the installation of a new node in the network system and the reconfiguration of an existing node may be facilitated.

One node of the present invention transmits and receives heartbeat data packets from another node on a regular basis. When one node learns that it has a newer data entry, such as a new operating information of a node, than another node, it will send a synchronisation data packet to the another node having an older data entry for update. Thus, only two types of data packet are needed to transmit between two nodes during a synchronisation cycle: 1) the heartbeat data packet, and 2) the synchronisation data packet.

Further, the synchronisation between two nodes can be automatically initialised by one node when it realises that it has a newer data entry than the other node. That is, in the present invention, no special “request for synchronisation” is needed for initializing the synchronisation between two nodes. Consequently, every node in the present invention have a same status for initialising the synchronisation.

It is also advantageous as one node may work as a temporary “master” node for triggering the synchronization of other nodes, and the other nodes may work as a “slave” node for synchronizing upon the “master” node. Thus, a data synchronization can be achieved between a plurality of nodes in the network system, without a central control node or any human intervention. Since each node may perform as the “master” node to trigger synchronization of other nodes, a floating master network system is achieved.

The node may be further configured to receive a second synchronizing data packet comprising a second data entry ID, a second data entry version identifier, and at least a portion of a second data payload, of a second data entry in said another node's data storage unit. A size of the second synchronizing data packet is greater than a size of the second data packet. When the second data entry version identifier of the second synchronizing data packet is indicated as newer than a data entry version identifier of a corresponding data entry in the data storage unit, the node is configured to update the data payload and the data entry version identifier of the corresponding data entry in the data storage unit, according to the portion of the second data payload and the second data entry version identifier of the second synchronizing data packet.

The node may be configured to determine that the data entry stored in its storage unit is newer than the corresponding data entry in said another node based on a change in its data payload and/or a change in its data version identifier.

The node may be configured to determine that the data entry stored in its storage unit is newer than the corresponding data entry in said another node based on that the data entry version identifier of the second heartbeat data packet is indicated as older than the data entry version identifier of the corresponding data entry in the data storage unit.

The node may be configured such that the first synchronization data packet comprises a portion of the data payload, said portion being a subset of the data payload of that data entry, and wherein the first synchronization data packet further comprises an indication of total data payload size for the data entry and/or a data payload portion order indicator.

In this case, the node may be configured to merge data payloads from two or more synchronization packets. Such merger may be performed based on the data payload size and data payload portion order indicators.

Moreover, in this case, the node may be configured to update a data entry version identifier only after at least two, preferably all, synchronization packets have been received in respect of a data entry.

The node may be configured to transmit the first heartbeat data packet only for data entries that meet a predetermined criterion, such as a data entry ID or a data entry ID range.

The node may be configured to receive said heartbeat second data packet only if the data entry ID of the second heartbeat data packet meets a predetermined criterion, such as a data entry ID or data entry ID range.

The node may further comprise a second interface for communicating with an external unit.

The node may be further configured to receive a first signal from the external unit, via the second interface, for updating a data payload of a data entry in the data storage unit; and/or provide a second signal to the external unit, via the second interface, for controlling the external unit.

The node may be configured to, when the first signal is received, update the data payload of the data entry in the data storage unit according to the first signal; and update the data entry version identifier of the updated data entry to indicate a newer version.

The external unit may comprise an actuator, a sensor, a tag writer, a tag reader, camera, photo eyes, push button, keyboard, cell phone, smart device, scanner, or the like.

The data entry version identifier may comprise a counter or a time stamp.

The operating information may comprise an operating mode, such as a node configuration, and/or an operating status, such as a sensor state or an error state.

The first interface may comprise a wireless interface or a wired interface, such as, but not limited to, a serial interface using a protocol selected from a group consisting of CAN, Ethernet, PROFIBUS, ProfiNET, I2C, SPI, and RS-485.

The second interface may be a single interface or two or more separate interfaces.

The data entry version identifier of the updated data entry may be updated by performing an arithmetic operation on a value of the counter, the arithmetic operation comprising adding and/or subtracting a predetermined number to and/or from the value of the counter, preferably, the predetermined number is 1.

The operating information may comprise an operating mode and/or an operating status.

The node may be configured to transmit the first heartbeat data packet to at least one node different from the node and said another node. The node may be configured to transmit the first heartbeat data packet to all nodes which are accessible.

The node may be configured to receive a heartbeat data packet transmitted by said at least one node, via the first interface, said heartbeat data packet comprising data entry ID and data entry version identifier of a data entry of said at least one node; and compare the received data entry version identifier of said heartbeat data packet, with a data entry version identifier of a corresponding data entry in the data storage unit having a same data entry ID as said heartbeat data packet; wherein, when the node determines that the data entry stored in its storage unit is newer than the corresponding data entry in said at least one node, the node is configured to transmit to said at least one node a synchronizing data packet comprising the data entry ID, the data entry version identifier, and at least a portion of the data payload, of the corresponding data entry in the data storage unit; wherein a size of said synchronizing data packet is greater than a size of the first heartbeat data packet.

The data payload may further represent operating information of at least one node different from the node and said another node. The data payload may represent operating information of all nodes. According to a second aspect, there is provided a network system comprising a first and a second node.

The first node comprises a first data storage unit configured to store a plurality of first data entries, each first data entry comprising a data entry ID, a data entry version identifier, and a data payload representing operating information of the first node or the second node; a first processing unit; and a first interface for communicating with the second node.

The second node comprises a second data storage unit configured to store a plurality of second data entries, each second data entry comprising a data entry ID, a data entry version identifier, and a data payload representing operating information of the first node or the second node; a second processing unit; and a second interface for communicating with the first node.

The first node is configured to transmit a first heartbeat data packet comprising data entry ID and data entry version identifier of a first data entry in the first data storage unit, via the first interface, to the second node; receive a second heartbeat data packet transmitted by the second node, via the first interface, the second data packet comprising data entry ID and data entry version identifier of a second data entry of the second node; and compare the received data entry version identifier of the second heartbeat data packet, with a data entry version identifier of a corresponding data entry in the data storage unit having a same data entry ID as the second data packet. When the first node determines that the data entry stored in its storage unit is newer than the corresponding data entry in the second node, the first node is configured to transmit to the second node a first synchronizing data packet comprising the data entry ID, the data entry version identifier, and at least a portion of the data payload, of the corresponding first data entry in the data storage unit; wherein a size of the first synchronizing data packet is greater than a size of the first heartbeat data packet.

The second node is configured to transmit the second heartbeat data packet comprising data entry ID and data entry version identifier of the second data entry of the second node; receive the first synchronizing data packet comprising the data entry ID, the data entry version identifier, and at least the portion of the data payload, of the corresponding first data entry in the first data storage unit; and compare the received data entry version identifier of the first synchronizing data packet, with data entry version identifier of the second data entry in the second data storage unit; and wherein when the data entry version identifier of the first synchronizing data packet is indicated as newer than the data entry version identifier of the second data entry in the second data storage unit, and when the first synchronizing data packet comprises a portion of a data payload associated to the same data entry ID as the second data entry in the second data storage unit, the second node is configured to update the data payload and the data entry version identifier of the second data entry in the second data storage unit, according to the portion of the data payload and the data entry version identifier of the first synchronizing data packet.

Two or more nodes as defined by way of introduction may be used in the network system.

The first node may further comprise a second interface for communicating with an external unit.

According to a third aspect, there is provided a method of data synchronization between a plurality of nodes forming part of a network system, wherein each node comprises a data storage unit configured to store a plurality of data entries, each data entry comprising a data entry ID, a data entry version identifier, and a data payload representing operating information of the node or another node; a processing unit; and a first interface for communicating with said another node.

The method comprises, in each node transmitting a first heartbeat data packet comprising data entry ID and data entry version identifier of a data entry in the data storage unit, via the first interface, to other nodes; receiving a second heartbeat data packet transmitted by said another node, via the first interface, the second data packet comprising data entry ID and data entry version identifier of a data entry of said another node; and comparing the received data entry version identifier of the second heartbeat data packet, with a data entry version identifier of a corresponding data entry in the data storage unit having a same data entry ID as the second heartbeat data packet. When the node determines that the data entry stored in its storage unit is newer than the corresponding data entry in said another node, the method comprises transmitting to said another node a first synchronizing data packet comprising the data entry ID, the data entry version identifier, and at least a portion of the data payload, of the corresponding data entry in the data storage unit. A size of the first synchronizing data packet is greater than a size of the first heartbeat data packet.

The first and second heartbeat data packets may consist essentially of the respective data entry ID and data entry version identifier.

The method may further comprise receiving a second synchronizing data packet comprising a second data entry ID, a second data entry version identifier, and at least a portion of a second data payload, of a second data entry in said another node's data storage unit, wherein a size of the second synchronizing data packet is greater than a size of the second data packet, and when the second data entry version identifier of the second synchronizing data packet is indicated as newer than a data entry version identifier of a corresponding data entry in the data storage unit, the method further comprises updating the data payload and the data entry version identifier of the corresponding data entry in the data storage unit, according to the portion of the second data payload and the second data entry version identifier of the second synchronizing data packet.

The method may further comprise transmitting the first heartbeat data packet to at least one node different from the node and said another node. The method may further comprise transmitting the first heartbeat data packet to all nodes which are accessible.

The method may further comprise receiving a heartbeat data packet transmitted by said at least one node, via the first interface, said heartbeat data packet comprising data entry ID and data entry version identifier of a data entry of said at least one node; and comparing the received data entry version identifier of said heartbeat data packet, with a data entry version identifier of a corresponding data entry in the data storage unit having a same data entry ID as said heartbeat data packet; wherein, when the node determines that the data entry stored in its storage unit is newer than the corresponding data entry in said at least one node, the method comprising: transmitting to said at least one node a synchronizing data packet comprising the data entry ID, the data entry version identifier, and at least a portion of the data payload, of the corresponding data entry in the data storage unit; wherein a size of said synchronizing data packet is greater than a size of the first heartbeat data packet.

The data payload may further represent operating information of at least one node different from the node and said another node. The data payload may represent operating information of all nodes.

The method can be performed by nodes and network systems comprising two or more such nodes, as described by way of introduction.

### BRIEF DESCRIPTION OF THE DRAWINGS

FIG. 1 is a schematic diagram of a network system according to the present disclosure.

FIG. 2 is a schematic diagram of a node according to the present disclosure.

FIG. 3 is a first example of data entries stored in a data storage unit of a node according to the present disclosure.

FIGS. 4a-4c is a second example of data entries stored in a data storage unit of a node according to the present disclosure.

FIG. 5 is a method flowchart according to the present disclosure.

### DESCRIPTION OF EMBODIMENTS

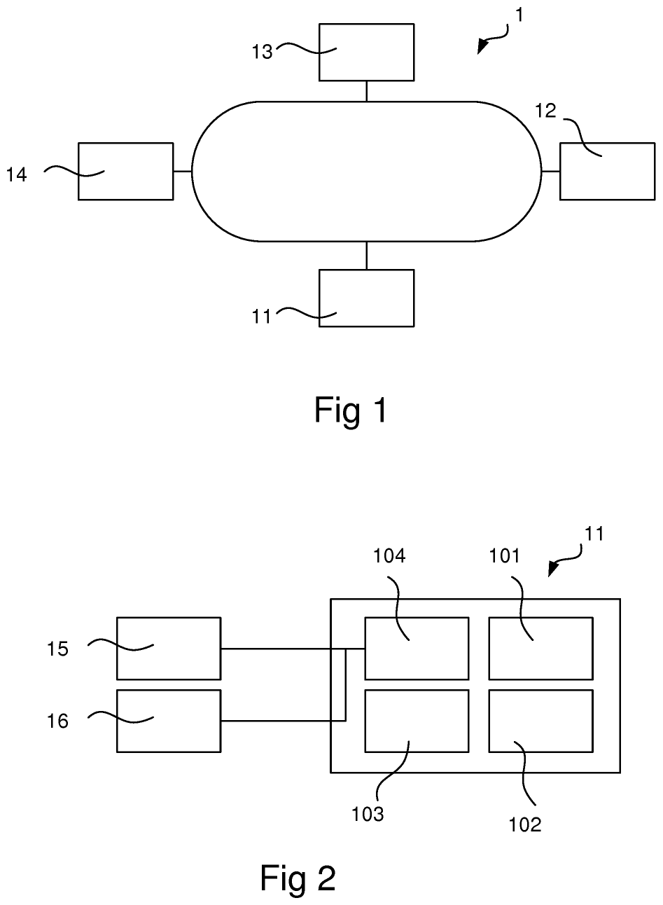

FIG. 1 illustrates a schematic diagram of a network system 1 according to the present disclosure. The network system 1 may comprise a plurality of nodes. For example, the network system 1 in FIG. 1 comprises four nodes 11, 12, 13, 14.

The network system 1 may comprise devices other than the nodes (not shown), such as devices for performing certain tasks, or HMI devices for receiving instructions from a user and/or for providing feedback to the user. The nodes may be associated with respective devices for performing certain tasks, such as a sensor, a micro-processor, an external hard drive, a keyboard, a display, a touch screen. The nodes 11, 12, 13, 14 may be a device for controlling and/or monitoring one or more devices of the network system.

As shown in FIG. 2, each node 11, 12, 13, 14 may comprise a data storage unit 101, a processing unit 102 and a first interface 103.

The data storage unit 101 can be any type of device or medium which is adapted for recording data or information in it. Data stored in the data storage unit can be read out. Any new data can be written in the data storage unit. Examples of such data storage units may be volatile or non-volatile memory devices, including but not limited to a CD-RW disk, a hard drive and a flash memory.

The processing unit 102 can be any type of device which is adapted for carrying out instructions by performing basic arithmetic, logical, control and input/output operations specified by the instructions. The processing unit may be a CPU, MCU, DSP, PLC or a single integrated circuit.

The first interface 103 may be used for communicating with one or more other nodes. The node may transmit a first data packet to another node or a plurality of other nodes in the network system, via the first interface 103. The node may receive a second data packet transmitted by one of the other nodes, via the first interface 103.

The first interface 103 may comprise a wireless interface. The second interface may comprise a wired interface. Consequently, the communication between one node and the other nodes may be wired and/or wireless. The wired interface may be a serial interface comprising a protocol selected from CAN, Ethernet, PROFIBUS, I2C, SPI, or RS-485. The wireless interface may enable wireless communications under standards selected from Wireless LAN, Wi-Fi, cellular networks, etc.

As shown in FIG. 2, each node 11, 12, 13, 14 may comprise a second interface 104 for communicating with an external unit. In FIG. 2, the second interface 104 communicates with two external units 15 and 16.

The second interface may be a single interface, or two or more separate interfaces.

The external unit 15, 16 may be an external hard drive, an actuator, a sensor, a tag writer, a tag reader, camera, photo eyes, push button, keyboard, cell phone, smart device, scanner, or the like.

The node 11, 12, 13, 14 may thus receive a first signal from the external unit 15, 16, via the second interface 104. Receipt of such a signal may cause the processing unit to update a data payload of a data entry in the data storage unit 101.

For example, on receipt of a signal indicating a data overflow of an external hard drive, the processor may update a corresponding data entry to indicate that a data overflow occurs in the external hard drive.

The node may provide a second signal, such as an instruction for controlling the external unit for performing a task, to the external unit, via the second interface 104.

For example, the node may provide a signal to the external hard drive for causing it to reboot.

The second interface 104 may comprise a wireless interface. Alternatively, the second interface may comprise a wired interface, such as a serial interface. Consequently, the communication between the node and the external unit via the second interface may be wired or wireless.

The present disclosure is particularly applicable to nodes 11, 12, 13, 14, which are configured to transmit information via a common communication network. The nodes 11, 12, 13, 14 may be configured to communicate in such a manner as to allow all nodes to receive all information that is communicated via the common communication network.

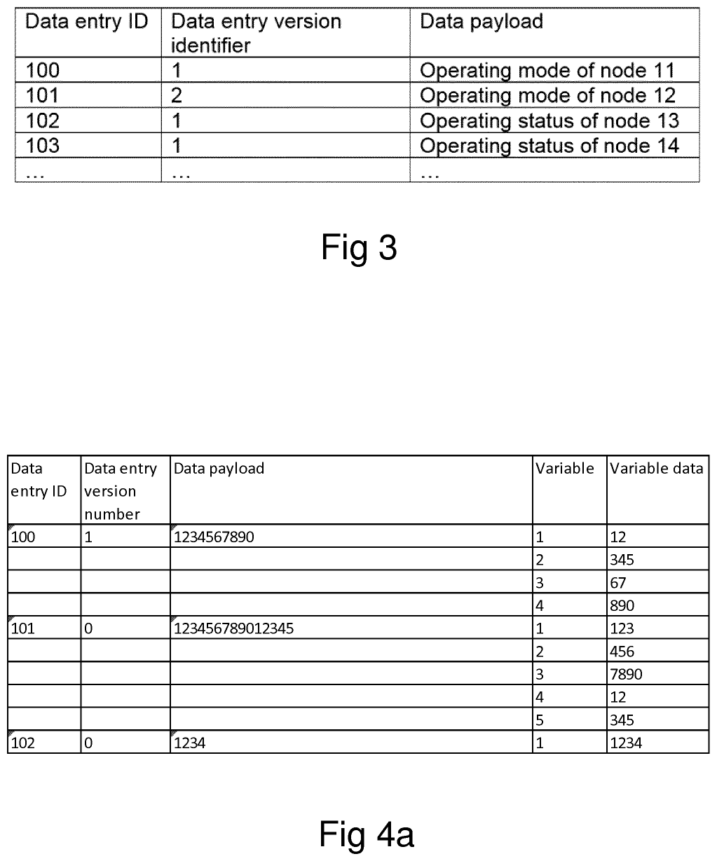

In the data storage unit 101, a plurality of data entries are stored. FIG. 3 is an example of data entries stored in a data storage unit 101 of the node 11, 12, 13, 14.

Each data entry may comprise a data entry ID, a data entry version identifier, and a data payload.

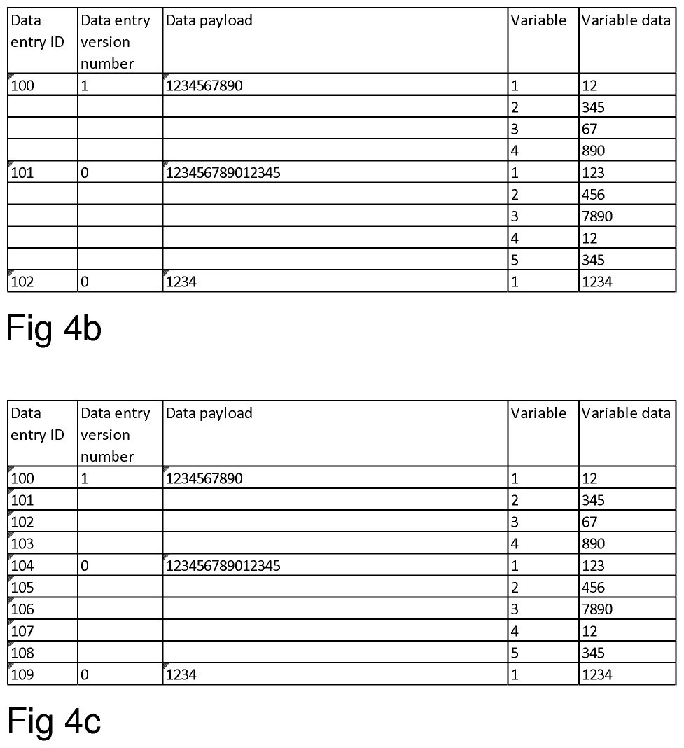

The data entry ID of each data entry may be unique, as shown in FIGS. 3, and 4a-4c. Thus, the unique data entry ID may be used to distinguish one data entry from other data entries.

The data payload may represent operating information of one node. The operating information may comprise an operating mode and/or an operating status of the node.

The operating mode may comprise operating configuration information, e.g., information of which function this or another node is to perform.

The operating status may comprise information of the actual status of the node, such as, it is in full capacity or it is malfunctioning. The operating status may indicate, as non-limiting examples, operating status of an external device, such as the operating status of the external hard drive. The data entry version identifier may indicate a version of the data entry. Thus, it may be used for representing whether the data entry is a newer or older when comparing with a corresponding data entry of e.g. another node.

The data entry version identifier may be a counter, as shown in FIGS. 3 and 4a-4c. When the data entry is updated, e.g. with an updated data payload, the counter may be updated by performing an arithmetic operation on a value of the counter. The value of the counter may be initially set as “0” for all data entries. For every update in one data entry, its data entry version identifier, i.e. the counter, may be increased by a predetermined value. The predetermined value may be “1”. Alternatively, other arithmetic operation, such as subtraction may also be performed on the value of the counter.

The data entry version identifier may be a time stamp. The time stamp may be initially set as “0” for all data entries when the system starts. For each update in the data entry after the system starts, a time stamp may be accorded as its data entry version identifier. The accorded time stamp may be a time interval calculated from when the system started until when the update happened.

If a real time system is used, each node in the network system may be synchronized by, e.g. a global clock signal for the system, an external common time server, or an external GPS signal, which would inevitably increase the complexity of the whole system. Moreover, the network system may comprise additionally a central node for synchronizing all the nodes in real time. Thus, using the data entry version identifier may simplify the network system.

Further, if a real time system is used, a minor miss-synchronization between two nodes may cause an error in the chronological order of the data entries such that the system is unable to function as desired. However, by using the time stamp instead of the real time, such a correct chronological order can be guaranteed by simply setting the time stamp to the initial value “0” when the system starts. Thus, using the data entry version identifier may improve the robustness of the network system.

Each node may store an entire data set comprising all the data entries of all the nodes in the network system. Alternatively, each node may store only a portion of the entire data set. For example, each node may store only the data entries of some nodes in the network system which are relevant to itself. In particular, a certain group of nodes may be configured such that each node stores complete information of the nodes forming that group.

FIGS. 4a-4c is a second example of data entries stored in a data storage unit of a node.

In FIG. 4a, it has been illustrated how each data entry may be devised to represent one or more variables of operating information as described above. In this example, the first data entry, data entry ID 100, which has a length of 10 positions, may represent four different variables. Hence, the data structure is defined such that the first two positions of the data payload represents variable 1; the next three positions represent variable 2; the next two positions represent variable 3 and the final three positions represent variable 4. This data structure definition is known by all nodes that need to be able to handle this data entry.

In a similar manner, the second data entry 101 may have a length of 15 positions, and be defined to represent five different variables and the third data entry 102 may have a data payload of four positions and represent a single variable.

A heartbeat data package would then have the form:

| | |
|---|---|
| 100 | 1, |

Where “100” represents the data entry ID and “1” represents the data entry version identifier.

A data synchronization packet may be defined such that the entire data payload of the data entry may be transmitted in one synchronisation data packet. Such a data synchronization packet only needs to contain the data entry ID, the data entry version identifier and the data payload. Hence, a synchronization data packet based on FIG. 4a may take the following form:

| | | |
|---|---|---|
| 100 | 1 | 1234567890. |

In FIG. 4b, there is illustrated a data structure for the transmission of a data synchronisation packet in a situation where the data payload length that is being transmitted is limited to four positions. That is, the data payload length is smaller than the total data payload associated with the particular data entry. Hence, the data entry is divided into three messages. In such case, it is necessary to provide information that will allow the receiving node to correctly patch together the entire data payload of the data entry based on two or more packets containing part of the data payload.

In FIG. 4b. an indication of data payload size and a flag, indicating which part of the data payload is being transmitted, have been provided. Hence, the receiving node will, based on knowledge that a maximum data payload size is four, be able to determine in which order the data payloads from the packets should be patched together. Hence, the data synchronization packets may take on the following form:

| | | | | |
|---|---|---|---|---|
| 100 | 1 | 15 | 1 | 1234, |
| 100 | 1 | 15 | 2 | 5678, |
| 100 | 1 | 15 | 3 | 90. |

25

As one alternative, the payload size for each data entry may be known by all the nodes, in which case only the flag is needed.

It is noted that in the example above, the payload flag forms a separate data field or a predetermined position in the data entry.

As one alternative, the payload flag may be included in one of the other data fields, such as in the data entry ID field. For example, the synchronization data packets for the first data entry 100 as per the example above may be:

| | | | |
|---|---|---|---|
| 1001 | 1 | 15 | 1234, |
| 1002 | 1 | 15 | 5678, |
| 1003 | 1 | 15 | 90. |

That is, the data field indicating the data entry ID may be expanded to indicate what part of this data entry is enclosed in the data packet.

Referring to FIG. 4c, as yet another alternative, the payload flag may be entirely dispensed with by determining that a certain range of data entry IDs together form one data entry, such that each synchronisation data package having an ID within that range can be identified as belonging to that data entry, whereby the receiving node will merge the data payloads of synchronization data packets having a data entry ID in said range. In this case, the corresponding data packets for the first data entry 100 may be

| | | | |
|---|---|---|---|
| 100 | 1 | 15 | 1234, |
| 101 | 1 | 15 | 5678, |
| 102 | 1 | 15 | 90. |

Also in this example, the data payload size may be omitted.

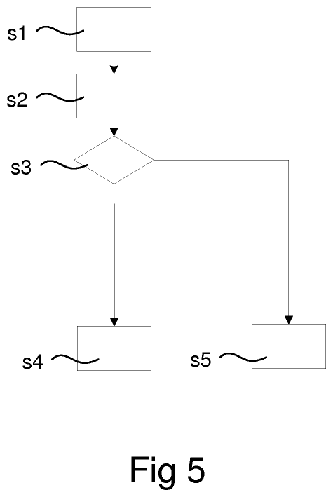

The description will now be directed to the operation of the network system 1 with reference to FIG. 5.

The node 11, 12, 13, 14 may be configured to transmit a first data packet comprising data entry ID and data entry version identifier of one or more, preferably all, data entries in the data storage unit, via the first interface 103, to other nodes, step s1. This transmission may be performed on a regular basis, as a heartbeat signal.

The node 11, 12, 13, 14 may be configured to receive one or more second data packets transmitted by one, some or all of the other nodes, via the first interface 103, wherein the second data packet comprises data entry ID and data entry version identifier of a data entry of said one of the other nodes, step s2. Hence, each node may transmit its own heartbeat signal as well as receive heartbeat signals from one or all of the other nodes.

The node 11, 12, 13, 14 may be configured to compare the received data entry version identifier of the second data packet, with a data entry version identifier of a corresponding data entry in the data storage unit having a same data entry ID as the second data packet, step s3. Typically, such comparison may be performed for each received second data packet.

The node may be configured to update the data payload of the data entry in the data storage unit, e.g., upon receipt of the first signal for updating a data payload and update the data entry version identifier of the updated data entry to indicate a newer version.

When the data entry version identifier of the second data packet is indicated as older than the data entry version identifier of the corresponding data entry in the data storage unit in step s3, the node may be configured to transmit the first synchronizing data packet comprising the data entry ID, the data entry version identifier, and at least a portion, preferably all, of the data payload, of the corresponding data entry in the data storage unit, wherein a size of the first synchronizing data packet is greater than a size of the first data packet, step s4.

Hence, when the node receives a data packet comprising an older data entry compared with the corresponding data entry in the node's data storage unit, the node sends out the most current corresponding data entry until all the nodes have updated in respect of the data entry.

When the data entry version identifier of the second data packet is indicated as newer than the data entry version identifier of the corresponding data entry in the data storage unit, and when the second data packet comprises a portion of a data payload associated to the same data entry ID as the corresponding data entry in the data storage unit, the node may be configured to update the data payload and the data entry version identifier of the corresponding data entry in the data storage unit, according to the portion of the data payload and the data entry version identifier of the second data packet, step s5.

If, on the other hand, the data entry version identifier of the second data packet is the same as that of the corresponding data entry in the storage unit, no synchronization operation needs to be carried out.

The data synchronization between a plurality of nodes 11, 12, 13, 14 of a network system 1 will be described in the following example involving two nodes 11, 12.

The first node 11 may have a data entry A-11 stored in its data storage unit. The data entry A-11 may have a data entry ID 100, a data entry version identifier 1, and a data payload comprising information of an operating status of the first node 11.

The second node 12 may have a data entry A-12 stored in its data storage unit. The data entry A-12 may be a copy of the data entry A-11. Consequently, the data entry A-12 may also have the data entry ID 100, the data entry version identifier 1, and the data payload comprising information of the operating status of the first node 11, as the data entry A-11.

The first node 11 may receive a signal from an external hard drive indicating a data overflow of the external hard drive.

On receipt of the signal, the processing unit 102 of the node 11 may cause an update of the data payload of data entry A-11. Thus, in the updated data entry A′-11, the updated data payload may indicate the data overflow of the external hard drive. In consequence, the node 11 may update the data entry version identifier of the updated data entry A′-11 to indicate a newer version. For example, the data entry version identifier of A′-11 may be updated from 1 to 2.

That is, the change in data payload for a data entry may trigger the sending of the synchronization data packet.

Alternatively, it is possible to trigger sending of the data synchronization packet in response to a first node discovering that received heartbeat data packets have an older data entry version identifier.

The second node 12 may transmit a second data packet comprising data entry ID 100 and data entry version identifier 1 of the data entry A- 12, to the first node 11.

The first node 11 may receive the second data packet transmitted by the second node 12. Since the received data entry ID is 100, the first node 11 may compare the received data entry version identifier 1 of the received second data packet, with the data entry version identifier 2 of the corresponding data entry A′-11 in its data storage unit, which has the same data entry ID 100.

After comparing, it is concluded that the data entry version identifier 1 of the second data packet is indicated as older than the data entry version identifier 2 of the corresponding data entry A′-11. That is, the data entry A-12 of the second node 12, which corresponds to data entry A-11, is not as updated as the updated data entry A′-11 of the first node 11.

On detection of an older version of the data entry A-12 of the received second data packet, the first node 11 may transmit a first synchronizing data packet comprising the data entry ID 100, the data entry version identifier 2, and at least a portion of the data payload indicating the data overflow of the external hard drive, of the updated data entry A′-11.

As comprising the additional data payload for updating, the size of the first synchronizing data packet may be greater than a size of the data packet it sent previously.

The second node 12 may receive the first synchronizing data packet transmitted by the first node 11. The first synchronizing data packet may comprise data entry ID 100, data entry version identifier 2 and the part of the data payload indicating the data overflow of the external hard drive, of the updated data entry A′-11 of the first node 11.

Since the data entry ID of the received first synchronizing data packet is 100, the second node 12 may compare the received data entry version identifier 2 of the first synchronizing data packet, with the data entry version identifier 1 of the corresponding data entry A-12 in its data storage unit, which has the same data entry ID 100.

After comparing, it is concluded that the data entry version identifier 2 of the first synchronizing data packet is indicated as newer than the data entry version identifier 1 of the corresponding data entry A-12. That is, the data entry A-12 stored in the second node 12, being a copy of data entry A-11, is not as updated as the updated data entry A′-11 stored in the first node 11.

Upon detection of a newer version of the data entry A′-11 of the node 11, and that the first synchronizing data packet comprises a portion of a data payload belonging to the corresponding data entry A′-11 in the data storage unit of the node 11, the second node 12 may update the data payload and the data entry version identifier 1 of the data entry A-12, according to the received first synchronizing data packet.

The updated data entry A′-12 may have a data entry ID 100, an updated data entry version identifier 2, and the updated data payload indicating the data overflow of the external hard drive as that of the data entry A′-11. That is, the updated data entry A′-12 stored in the second node 12 is updated as a copy of the updated data entry A′-11 of the first node 11.

The second node 12 will continue to send out second data packets indicating the old data entry version until the data entry has been updated. After the data entry has been updated, the node 12 will update also the data entry version identifier.

In the event more than one data synchronization packets need to be transmitted, then the second node 12 may defer updating its data entry version identifier until all data synchronization packets have been received and the corresponding data payload has been received in its entirety.

Optionally, the node 12 may send a first notification to the node 11 to inform the node 11 that the first synchronizing data packet is received completely, stored completely, and/or the update is successfully. The first notification may be a data packet comprising the data entry ID 100 and the updated data entry version identifier 2 of the updated data entry A′-12.

Optionally, the second node 12 may send a second notification comprising the data entry version identifier 1 and the data entry ID 100 of the data entry A-12 to the first node 11, until the first synchronizing data packet is received completely, stored completely, and/or the update is successfully. The second notification may be used to inform the first node 11 that the first synchronizing data packet has not been completely received, not been completely stored, and/or the update is not completed yet.

Other nodes 13, 14 in the network system 1 may each comprise a data entry A-13 and A-14, respectively, as a copy of the data entry A-11 of the node 11. The other nodes 13, 14 may also perform the same synchronization as the nodes 11, 12, such that the updated data entry version identifier for the updated data entries A′-13 and A′-14 may also be updated to 2, as the updated data entry A′-12. Afterwards, the first node 11 may not receive data packet from the second node 12 and the other nodes 13, 14 in which the data entry version identifier for the data entry having data entry ID 100 is indicated as older than the data entry version identifier 2.

The first node 11 may transmit a second synchronizing data packet comprising the data entry ID 100, the data entry version identifier 2, of the data entry A′-11 in its data storage unit. The size of the second synchronizing data packet may be less than the size of the first synchronizing data packet.

That is, after all the nodes 12, 13, 14 in the network system are synchronized to the updated data entry A′-11, it is not necessary for the node 11 to continue transmitting the first synchronizing data packet comprising any data payload. The first node 11 may start transmitting data packet with a smaller size comprising only the data entry ID 100 and the data entry version identifier 2 of the updated data entry A′-11, or comprising the data entry ID 100, the data entry version identifier 2, and a small portion of the data payload, of the updated data entry A′-11.

When a new node needs to be installed in the network system 1 comprising a plurality of the present node 11, 12, 13, 14, the new node may be configured to comprise data entries having an old data entry version identifier, e.g., “0”. Thus, the new node may be automatically synchronized to the other existing nodes 11, 12, 13, 14 by the synchronization triggered by those nodes having “newer” data entries. Thus, the installation of a new node in the network system may be facilitated.

When the node 11 needs to be reconfigured, the node may be automatically synchronized to the other nodes by the synchronization triggered by those nodes having “newer” data entries, without any human intervention. Thus, the reconfiguration of the existing nodes may be facilitated.

In the data entry structures disclosed in FIGS. 4a-4c, an additional field may be included, which may be used to indicate whether the node needs this data entry or not. Based on such a field, it is possible for nodes to ignore all data packets relating to data entries that are not needed.

The network system may further comprise a flow configurator, i.e. a device used to determine the functions of each node. Such determination may be made based on input from a user interface or based on a configuration plan that has been received. The flow configurator may communicate in the same manner as described above with regard to the nodes, with the difference that its payload may be manipulated through the user interface or through the configuration plan.

Hence, configuring the nodes may be achieved by updating some or all of the flow configurator's data entries. Hence, the flow configurator will begin to send out updated data entries as soon as it starts receiving messages from other nodes indicating that they have older data entries.

Moreover, a node may be introduced by assigning to it a certain function, such that it will know what data it needs to receive and store, and its data entries may be reset to a very low data entry version indicator value, such as 0 or 1, whereby, when it is introduced into an existing network system, and begin to send out the first heartbeat data packets, other nodes will recognize that there is a node with an older data version, and thus begin to send out synchronization data packets to allow the new node to update its data entries.

1. A node for a data communication network, comprising:
a data storage unit configured to store a plurality of data entries, each data entry comprising a data entry ID, a data entry version identifier, and a data payload representing operating information of the node or another node;
a processing unit; and
a first interface for communicating with said another node;
wherein the node is configured to
transmit a first heartbeat data packet comprising data entry ID and data entry version identifier of a data entry in the data storage unit, via the first interface, to other nodes;
receive a second heartbeat data packet transmitted by said another node, via the first interface, the second heartbeat data packet comprising data entry ID and data entry version identifier of a data entry of said another node; and
compare the received data entry version identifier of the second heartbeat data packet, with a data entry version identifier of a corresponding data entry in the data storage unit having a same data entry ID as the second heartbeat data packet;
wherein, when the node determines that the data entry stored in its storage unit is newer than the corresponding data entry in said another node, the node is configured to transmit to said another node a first synchronizing data packet comprising the data entry ID, the data entry version identifier, and at least a portion of the data payload, of the corresponding data entry in the data storage unit;
wherein a size of the first synchronizing data packet is greater than a size of the first heartbeat data packet.

2. The node as claimed in claim 1, the node is further configured to receive a second synchronizing data packet comprising a second data entry ID, a second data entry version identifier, and at least a portion of a second data payload, of a second data entry in said another node's data storage unit,
wherein a size of the second synchronizing data packet is greater than a size of the second heartbeat data packet,
wherein, when the second data entry version identifier of the second synchronizing data packet is indicated as newer than a data entry version identifier of a corresponding data entry in the data storage unit, the node is configured to update the data payload and the data entry version identifier of the corresponding data entry in the data storage unit, according to the portion of the second data payload and the second data entry version identifier of the second synchronizing data packet.

3. The node as claimed in claim 1, wherein the node is configured to determine that the data entry stored in its storage unit is newer than the corresponding data entry in said another node based on a change in its data payload and/or a change in its data version identifier.

4. The node as claimed in claim 1, wherein the node is configured to determine that the data entry stored in its storage unit is newer than the corresponding data entry in said another node based on that the data entry version identifier of the second heartbeat data packet is indicated as older than the data entry version identifier of the corresponding data entry in the data storage unit.

5. The node as claimed in any one of the claim 1,
wherein the node is configured such that the first synchronization data packet comprises a portion of the data payload, said portion being a subset of the data payload,
wherein the first synchronization data packet further comprises an indication of total data payload size for the data entry and/or a data payload portion order indicator.

6. The node as claimed in claim 1, wherein the node is configured to transmit the first heartbeat data packet only for data entries that meet a predetermined criterion, such as a data entry ID or a data entry ID range.

7. The node as claimed in claim 1, wherein the node is configured to receive said heartbeat second data packet only if the data entry ID of the second heartbeat data packet meets a predetermined criterion, such as a data entry ID or data entry ID range.

8. The node as claimed in any one of the claim 1, further comprising a second interface for communicating with an external unit.

9. The node as claimed in claim 8, wherein the node is further configured to:
receive a first signal from the external unit, via the second interface, for updating a data payload of a data entry in the data storage unit; and/or
provide a second signal to the external unit, via the second interface, for controlling the external unit.

10. The node as claimed in claim 9, wherein, when the first signal is received, the node is configured to:
update the data payload of the data entry in the data storage unit according to the first signal; and
update the data entry version identifier of the updated data entry to indicate a newer version.

11. The node as claimed in claim 1, wherein the data entry version identifier comprises a counter or a time stamp.

12. The node as claimed in claim 1, wherein the operating information comprises an operating mode, such as a node configuration, and/or an operating status, such as a sensor state or an error state.

13. The node as claimed in claim 1, wherein the node is configured to
transmit the first heartbeat data packet to at least one node different from the node and said another node.

14. The node as claimed in claim 13, wherein the node is configured to
receive a heartbeat data packet transmitted by said at least one node, via the first interface, said heartbeat data packet comprising data entry ID and data entry version identifier of a data entry of said at least one node; and
compare the received data entry version identifier of said heartbeat data packet, with a data entry version identifier of a corresponding data entry in the data storage unit having a same data entry ID as said heartbeat data packet;
wherein, when the node determines that the data entry stored in its storage unit is newer than the corresponding data entry in said at least one node, the node is configured to transmit to said at least one node a synchronizing data packet comprising the data entry ID, the data entry version identifier, and at least a portion of the data payload, of the corresponding data entry in the data storage unit;
wherein a size of said synchronizing data packet is greater than a size of the first heartbeat data packet.

15. The node as claimed in claim 1, wherein the data payload further represents operating information of at least one node different from the node and said another node.

16. A network system comprising a first and a second node,
wherein the first node comprises:
a first data storage unit configured to store a plurality of first data entries, each first data entry comprising a data entry ID, a data entry version identifier, and a data payload representing operating information of the first node or the second node;
a first processing unit; and
a first interface for communicating with the second node;
wherein the second node comprises:
a second data storage unit configured to store a plurality of second data entries, each second data entry comprising a data entry ID, a data entry version identifier, and a data payload representing operating information of the first node or the second node;
a second processing unit; and
a second interface for communicating with the first node;
wherein the first node is configured to:
transmit a first heartbeat data packet comprising data entry ID and data entry version identifier of a first data entry in the first data storage unit, via the first interface, to the second node;
receive a second heartbeat data packet transmitted by the second node, via the first interface, the second data packet comprising data entry ID and data entry version identifier of a second data entry of the second node; and
compare the received data entry version identifier of the second heartbeat data packet, with a data entry version identifier of a corresponding data entry in the data storage unit having a same data entry ID as the second data packet;
wherein, when the first node determines that the data entry stored in its storage unit is newer than the corresponding data entry in the second node, the first node is configured to:
transmit to the second node a first synchronizing data packet comprising the data entry ID, the data entry version identifier, and at least a portion of the data payload, of the corresponding first data entry in the data storage unit;
wherein a size of the first synchronizing data packet is greater than a size of the first heartbeat data packet; and
wherein the second node is configured to:
transmit the second heartbeat data packet comprising data entry ID and data entry version identifier of the second data entry of the second node;
receive the first synchronizing data packet comprising the data entry ID, the data entry version identifier, and at least the portion of the data payload, of the corresponding first data entry in the first data storage unit; and
compare the received data entry version identifier of the first synchronizing data packet, with data entry version identifier of the second data entry in the second data storage unit; and
wherein when the data entry version identifier of the first synchronizing data packet is indicated as newer than the data entry version identifier of the second data entry in the second data storage unit, and when the first synchronizing data packet comprises a portion of a data payload associated to the same data entry ID as the second data entry in the second data storage unit, the second node is configured to:
update the data payload and the data entry version identifier of the second data entry in the second data storage unit, according to the portion of the data payload and the data entry version identifier of the first synchronizing data packet.

17. A method of data synchronization between a plurality of nodes of a network system,
wherein each node comprises:
a data storage unit configured to store a plurality of data entries, each data entry comprising a data entry ID, a data entry version identifier, and a data payload representing operating information of the node or another node;
a processing unit and
a first interface for communicating with said another node;
the method comprising, in each node:
transmitting a first heartbeat data packet comprising data entry ID and data entry version identifier of a data entry in the data storage unit, via the first interface, to other nodes;
receiving a second heartbeat data packet transmitted by said another node, via the first interface, the second data packet comprising data entry ID and data entry version identifier of a data entry of said another node; and
comparing the received data entry version identifier of the second heartbeat data packet, with a data entry version identifier of a corresponding data entry in the data storage unit having a same data entry ID as the second heartbeat data packet;
wherein, when the node determines that the data entry stored in its storage unit is newer than the corresponding data entry in said another node, the method comprises:
transmitting to said another node a first synchronizing data packet comprising the data entry ID, the data entry version identifier, and at least a portion of the data payload, of the corresponding data entry in the data storage unit;
wherein a size of the first synchronizing data packet is greater than a size of the first heartbeat data packet.

18. The method as claimed in claim 17, further comprising:
receiving a second synchronizing data packet comprising a second data entry ID, a second data entry version identifier, and at least a portion of a second data payload, of a second data entry in said another node's data storage unit,
wherein a size of the second synchronizing data packet is greater than a size of the second data packet, and
when the second data entry version identifier of the second synchronizing data packet is indicated as newer than a data entry version identifier of a corresponding data entry in the data storage unit, the method further comprises updating the data payload and the data entry version identifier of the corresponding data entry in the data storage unit, according to the portion of the second data payload and the second data entry version identifier of the second synchronizing data packet.

19. The method as claimed in claim 17, further comprising:
transmitting the first heartbeat data packet to at least one node different from the node and said another node.

20. The method as claimed in claim 19, further comprising:
receiving a heartbeat data packet transmitted by said at least one node, via the first interface, said heartbeat data packet comprising data entry ID and data entry version identifier of a data entry of said at least one node; and
comparing the received data entry version identifier of said heartbeat data packet, with a data entry version identifier of a corresponding data entry in the data storage unit having a same data entry ID as said heartbeat data packet;
wherein, when the node determines that the data entry stored in its storage unit is newer than the corresponding data entry in said at least one node, the method comprising:
transmitting to said at least one node a synchronizing data packet comprising the data entry ID, the data entry version identifier, and at least a portion of the data payload, of the corresponding data entry in the data storage unit;
wherein a size of said synchronizing data packet is greater than a size of the first heartbeat data packet.

21. (canceled)
